(19) United States
(12) Patent Application Publication
(10) Pub. No.: US 2006/0287849 A1
(43) Pub. Date: Dec. 21, 2006

(54) Words for managing health & health-care information

(76) Inventors: Anuthep Benja-Athon, New York, NY (US); Nontawan Benja-Athon, Port Washington, NY (US); Sirikit Benja-Athon, Port Washington, NY (US)

Correspondence Address: ANUTHEP BENJA-ATHON, 210 E 36TH STREET, NEW YORK, NY, 10016, US

(21) Appl. No.: 11/510,820

(22) Filed: Aug. 28, 2006

Related U.S. Application Data
(63) Continuation-in-part of application No. 11/477,121, filed on Jun. 29, 2006.
(63) Continuation-in-part of application No. 11/327,973, filed on Jan. 9, 2006.
(63) Continuation-in-part of application No. 11/344,485, filed on Feb. 1, 2006.
(63) Continuation-in-part of application No. 11/114,763, filed on Apr. 27, 2005.

(51) Int. Cl. G06F 17/27

(52) U.S. Cl. 704/9

(57) ABSTRACT

A system and method of coupling words and terms of a first vocabulary with words, terms, phrases and sentences of a second vocabulary for administering and managing data on patients generated by physicians. The first vocabulary enables the administrations, managements, storage, retrievals, uses and communications of digital voice and text data in a network or networks of electronic equipment and devices.

This application is a continuation-in-part of Ser. No. 11/477,121 entitled Medical vocabulary templates in speech recognition filed Jun. 29, 2006, and a continuation-in-part of Ser. No. 11/327,973 entitled the Fidelity of Physicians' Thoughts to Digital Data Conversions filed on Jan. 9, 2006, and a continuation-in-part of Ser. No. 11/344,485 entitled Physicians-Patients-Health-Care-Buyers Accounting System filed Feb. 1, 2006, and a continuation-in-part of Ser. No. 11/114,763 entitled System of Influencing Health-Care Utilizations filed Apr. 27, 2005—all are pending.

### FIELD OF INVENTION

A system of words and terms for managing health and health-care data.

### BACKGROUND OF THE INVENTION

The present invention is a unique and foremost system and method of using a vocabulary of words and terms by physicians for administering and managing health, health-care and health-care related data on patients generated by physicians and on physicians in a network or networks of electronic equipment, devices, computers and servers.

The present invention is a unique and foremost system and method for not only administering and managing health, health-care and health-care related data on patients and physicians in a network or networks of computers and servers but also to manage, administer, store, use, sort, retrieve, file, query, mine, develop, grow, extract, research and communicate said data and the derivatives and related of said data in a network or networks of electronic equipment, devices, computers and servers.

Specifically, the present invention is a system and a method of administering and using appropriate streams, strings or lists of logical sequences of coupled, paired or linked words, terms, phrases and sentences by, first, physicians who administer, use and articulate said streams, strings or lists of sequences of couples or pairs into electronic devices or equipment such as, but not limited to, digital voice recorders, smart phones, cellular phones, multimodal applications, wireless devices and equipment, microphones, thus generating files of digital voice, speech or audio data on said patients, and said physicians, and, second, by computers or servers with their computer program/programs and/or software to computer-automatically administer and use said digital files each of which comprises said data adaptable to manage and administer said digital voice, speech or audio data as said data (plural) arrive in and being processed in the computers and/or servers infra and to administer the conversions of said data into digital text data and to further manage, administer, store, manage, use, sort, retrieve, file, query, mine, develop, grow, extract, research and communicate said data and the derivatives and related of said health, health-care and health-care related data on said patients and said physicians in a network or networks of electronic equipment, devices, computers and servers.

The present invention is most innovative and practical means for administering, using, managing and communicating said data on millions of patients and tens or hundreds of thousands of physicians to benefits said patients, physicians and humanity.

Consequently, the present invention will rapidly cause the widespread applications of the best health-care system for improving the American health-care with all the human and socioeconomic benefits for all Americans and the world as provide by the earlier pending patent applications of these physician applicant and his co-applicants.

A fundamental to the rapid achievement of the goals set by said patent applications is the present invention which provides the most effective electronic system of allowing the computer programs and software in a network or networks of computers and servers to computer-automatically administer, use, store, manage, sort, file, develop, grow, extract, research and communicate said data and the derivatives and related of said data to benefit said physicians, patients, medicine, science and humanity.

The present invention's benefits and benevolent affects on humanity are immense as the present invention will surely cause billions of health-care dollars, tangible and intangible benefits per day to positively affect and improve the lives of millions of people in America and the world.

### SUMMARY OF THE INVENTION

The present invention is most innovative and practical means for administering, managing and communicating health and health-care data on millions of patients and tens or hundreds of thousands of physicians in the networks of equipment and electronic devices and to benefit patients, physicians and humanity.

The present invention is a system and method of coupling words and terms of a first vocabulary with words, terms, phrases and sentences of a second vocabulary for administering, managing and using data on patients generated by physicians. The first vocabulary enables the administrations, managements, storage, retrievals, uses and communications of digital voice and text data in a network or networks of electronic equipment and devices. The present invention comprises a system and a method of using said vocabularies by physicians and by computers and servers for administering and managing said data and the derivatives and related of said data in computers and/or servers in said networks of computers and servers for physicians and patients.

### DESCRIPTION OF THE PREFERRED EMBODIMENTS

The present invention is a system and a method of administering and using a vocabulary of words and terms by physicians for administering and managing health, health-care and health related information on patients generated by physicians using electronic devices and equipment and for administering and managing the derivatives of said information—digital text data which are stored in and retrievable from databases—produce by computer program or programs and software in the computers and/or servers in a network or networks of computers and servers for physicians and patients.

The present invention is a system and method of administering and using a vocabulary of words and terms like or analogous to the prefixes and/or suffixes—however, it is to be understood that said prefixes and suffixes in one of the preferred embodiments of the present invention are words and terms use by physicians and are words and terms preceding or succeeding other words, terms, phrases and sentences use by physicians in all medical and surgical specialties, fields, or practices which following said prefixes as illustrated in Examples infra or before said suffixes, respectively—by physicians using various electronic equipment and devices to generate and produce digital voice, speech or audio data comprising said health, health-care and health related information on patients and, consequently, on said physicians for managing, administering, storing, using, sorting, filing, extracting, developing, growing, researching and communicating health, health-care and health related information on patients generated by physicians and on physicians and the derivatives and related in a network or networks of computers and server to benefit patients, physicians and humanity.

Specifically, the present invention is a system and a method of administering and using streams, lists or sequences of coupled, paired or linked words, terms, phrases and sentences by, first, physicians who administer, use and articulate said stream, streams, list, lists, sequence and/or sequences of said couples, pairs or links comprising words, terms, phrases and sentences in any combination thereof into said electronic devices or equipment thus generating files comprising digital voice, speech or audio data on said patients, and, second, by computers and/or servers with their computer program/programs and/or software to computer-automatically administer and use said digital data files each of which comprises said stream, streams, list, lists, sequence and/or sequences of couplings, pairs or links of said data to manage and administer said digital voice, speech or audio data as said data (plural) arrive in the computers and/or servers and administer and manage the conversions of said data into digital text data and further manage and administer, store in databases, manage, file, store, retrieve, use and query data from databases using Structured Query Language (SQL) and related such as PERL/PHP and the like and their derivatives produced by several corporations such as, but not limited to, Microsoft Corporation, Oracle Corporation, SyBase, Inc. and MySQL Corporation, mine, develop, grow, extract, research and communicate said data and the derivatives and related of said health, health-care and health-care related data on said patients and said physicians generated by said patients and physicians in a network or networks of computers and servers.

One of the preferred embodiments of the present invention is that the words and terms use by physicians to achieve said objectives comprises a vocabulary of words and terms. In general, said first vocabulary of words and terms or any combination thereof function as prefixes before and/or suffixes—in the context defined supra—after a second larger vocabulary or dictionaries of medical and surgical (and non-medical and non-surgical) words, terms, codes, phrases and sentences use by physicians in about 80 medical and surgical specialties, fields or practices of medicine and surgeries. In other words, said embodiments apply to and will be used by tens to hundreds of thousands of physicians in all medical and surgical specialties in America alone and other health-care professions.

A small representation of said first vocabulary of words and terms which in the present Description function as prefixes before said second larger vocabulary or dictionaries of medical and surgical (and non-medical and non-surgical) words and terms is such as, but not limited to, the following:

Consultation

Office visit

Drug Allergy

Food Allergy

Chief Complaint

Complaint

Duration

Diagnosis

Differential Diagnosis

Symptom

Sign

Manifestation

Treatment

Procedure

Prescription

Surgery

Pathology

Pathophysiology

Test

Recommendation

Referral

Finding

Hospital

Clinics

Messages

Another example, according to one of the preferred embodiments of the present invention, any neurologist, a group of neurologists, or groups of neurologists can use and administer said vocabulary of words and terms as prefixes and suffixes. However, another preferred embodiments applicable to a neurological specialty, said neurologist, group of neurologists, or groups of neurologists can use and administer supra in more specific means which may be more versatile for administering and using according to the spirit of the present invention:

Chief neurological complaint

Neurological Complaint

Duration

Diagnosis

Differential Diagnosis

Symptom

Neurological sign

Neurological manifestation

Treatment

Procedure

Prescription

Surgery

Pathology

Neurophysiology

Test

Electrodiagnosis

Electroencephalogram

Electroencephalograhy

Recommendation

Referred

Referral

Finding

Yet another example, according to one of the preferred embodiments of the present invention, any rheumatologist, a group of rheumatologists, or groups of rheumatologists can use and administer said vocabulary of words and terms as prefixes, suffixes and any combination thereof. However, another preferred embodiments applicable to a rheumatological specialty, said rheumatologist, a group of rheumatologists, or groups of rheumatologists can use and administer supra in more specific means which may be more versatile for administering and using according to the spirit of the present invention:

Chief rheumatological complaint

Rheumatological Complaint

Duration

Diagnosis

Differential Diagnosis

Symptom

Rheumatological sign

Rheumatological manifestation

Rheumatological finding

Treatment

Procedure

Prescription

Surgery

Pathology

Test

Recommendation

Referred

Referral

Finding

One of the preferred embodiments of the present invention includes the plural, derivatives, roots and related of said words and terms.

The above and related preferred embodiments apply to physicians in about 80 medical and surgical specialties or fields, practices of medicine and surgeries. In other words, said embodiments apply to tens to hundreds of thousands of physicians in all medical and surgical specialties in America alone and other health-care professions.

An example is a logical line, string or sequence of couples or pairs of health, health-care and health-care related data representing thousands—millions of logical and appropriate lines, strings or sequences of coupled or pair words, terms, phrases codes, sentences arising from numerous permutations, combinations, relationships, couplings or pairings of said words, terms, codes, phrases and sentences use by and applicable to said physicians in about 80 medical and surgical specialties or fields, practices of medicine and surgeries and use and administer by said program/programs and software in said computers and/or servers is as follows:

CHIEF COMPLAINT a→DURATION b→DIAGNOSE c—TEST d→PRESCRIPTION e→TREATMENT f→SURGERY g→RECOMMENDATION h

It is to be understood that alphabets—a, b, c, d, e, f, g and h, etc.—appearing after words and terms in said first vocabulary of words and terms represent a second larger vocabulary or dictionaries of medical and surgical (and non-medical and non-surgical) words, terms, phrases, codes, acronyms, lines or sentences, etc.—as illustrated in the Examples infra—are administered, dispensed and used by said physicians and for managing, administering, storing, using, sorting, filing, developing, growing, querying, mining, researching and communicating said health, health-care and health-care related data on patients by said computer program/programs and software in said computers and/or servers in a network or networks of computers and servers to benefit patients, physicians and humanity.

A description of the use of said second vocabulary is described in the present applicants' application number Ser. No. 11/477,121 entitled Medical Vocabulary Templates in Speech Recognition filed Jun. 29, 2006 and, in Examples infra, only four paragraphs of four sequences of coupled, paired or linked words, terms and phrases of thousands—millions of sequences applicable to about 80 medical and surgical specialties, fields or practices.

The following is just 5 examples representing the preferred embodiments of organizations, orders or combinations of words, terms, phrases and sentences applicable to said physicians in about 80 medical and surgical specialties or fields, practices of medicine and surgeries:

Complaint headache→Day 30 days→Diagnosis brain tumor→Test brain scan→Prescription brain radiation→Treatment radiation of brain tumor→Surgery excision of brain tumor→Recommendation admission into hospital

Chief complaint headache neck pain→Day 1030 days→Diagnosis cervicogenic headache→Test none→Prescription oral motrin muscle relaxant→Treatment physical therapy→Surgery cervical epidural steroid→Recommendation rest proper exercise

Chief neurological complaint headache fever chill→Day 15 days→Travel history swimming in fresh water pond→Diagnosis amoebic meningoencephalitis→Test stool smears→Prescription metronidazole 750 mg tid for 10 days→Treatment abscess aspiration→Surgery abscess drainage and excision→Recommendation surgical intensive unit life support

Complaint urethral bloody discharge→Day 5 days→Diagnosis bladder infection→Test urinalysis urine culture→Prescription oral cephalosporin drug bid→Procedure transurethra endoscopy→Recommendation rule out bladder tumor→Surgery excisional biopsy of mass

Chief urological complaint dysuria→Day 2 days→Diagnosis bladder infection→Test urinalysis urine culture→Prescription oral cephalosporin drug bid→Treatment irrigation of bladder→Procedure transurethra endoscopy→Recommendation observe

Said symbol “→” supra serves to describe or represent the relationships of said words, terms, phrases, acronyms, synonyms, codes and sentences in medicine and surgery use by physicians.

Furthermore, said physicians are taught the processes of thinking, articulating, administering and using the present invention as taught in present applicants' application Ser. No. 11/327,973 entitled the Fidelity of Physicians' Thoughts to Digital Data Conversions filed on Jan. 9, 2006 to achieve the objectives of the present invention.

Although various preferred embodiments of the present invention have been described, it is understood that word-word couplings, word-term couplings, word-phrase couplings; and word-sentence couplings mean the couplings of word, words, term, terms, phrase, phrases and sentences and any appropriate combinations and in any appropriate manners thereof to achieve the objectives of the present invention.

Although various preferred embodiments of the present invention have been described, it is understood that said coupling, pairing or linking process does also apply to processes wherein various, extensive and logical combinations and permutations of words, terms, codes, phrases and sentences are logically and meaningfully administered and used such as, but not limited to, words-words couplings, word-words couplings, word-term couplings, words-term couplings, words-terms couplings, word-phrase couplings, words-phrase couplings, words-phrases couplings, word-sentence couplings, words-sentence couplings, word-sentences couplings, words-sentences couplings, word-words-words couplings, words-words-words couplings, words-words-terms couplings, words-words-phrase couplings, and word-words-phrase-sentence couplings, etc. to achieve the objectives of the present invention.

Although various preferred embodiments of the present invention have been described, it is understood that the term also includes acronyms, synonyms and codes use and to be generated and created by physicians and health and health-care providers.

Although various preferred embodiments of the present invention have been described, it is to be understood that said words and terms in said first vocabulary of words and terms functioning as prefixes and/or suffixes are words and terms use in medical and surgical specialties, practices and/or fields. Similarly, words and terms in said secondary vocabulary or dictionaries of words and terms are words and terms use in medical and surgical specialties, practices and/or fields. Phrases and sentences are derived from said words and terms.

Although various preferred embodiments of the present invention have been described, it is to be understood that specialty and specialties infra also embody or comprise words, numbers, terms, phrases, sentences, codes and labels in pharmacology and pharmaceutics use by physicians and pharmacists such as, but not limited, names of drugs and medications, doses and uses and toxicology such as, but not limited to, names of toxic substances.

Although various preferred embodiments of the present invention have been described, it is understood that the preferred embodiments of the present invention apply to all medical and surgical specialties and practices and all other health and health-care specialties, professions and practices even though the above cited all or about 80 medical and surgical specialties and practices or fields of medicine and surgeries, health and health-care as a representation in the description of the preferred embodiments.

Although various preferred embodiments of the present invention have been described, it is understood that the preferred embodiments of the present invention apply to other health-care providers and it will be appreciated by those skilled in the art that adaptations and variations may be made in this setting without departing from the spirit of the invention and the scope of the claims.

Although various preferred embodiments of the present invention have been described for patients, physicians and other health-care providers, it will be appreciated by those skilled in the art that adaptations and variations may be made to apply to other businesses and industries such as, but not limited, law, lawyers and government and their clients, veterinarians and animals, engineering and engineers without departing from the spirit of the invention and the scope of the claims.

Although various preferred embodiments of the present invention have been described, it will be appreciated by those skilled in the art that adaptations and variations may be made without departing from the spirit of the invention and the scope of the claims.

1. A method of administering and using a vocabulary of words and terms by physicians for administering and managing health, health-care and health related information on patients generated by physicians and for administering and managing said information and the derivatives and related of said information in the computers and/or servers in a network or networks of computers and servers for physicians and patients comprises:
a process of using said vocabulary of words and terms by physicians;
a process of using words, terms, phrases and sentences by physicians;
a process of using word-word couplings;
a process of using word-term couplings;
a process of using word-phrase couplings; and
a process of using word-sentence couplings.

2. A system of a vocabulary of words and terms use by physicians for administering and managing health, health-care and health related data on patients generated by physicians using electronic devices and equipment and for administering and managing said data and the derivatives and related of said data in the computers and/or servers in a network or networks of computers and servers for physicians and patients comprises:
said vocabulary of words and terms;
words, terms, phrases and sentences;
word-word couplings;
word-term couplings;
word-phrase couplings; and
word-sentence couplings.

3. A system of coupling words and terms of a first vocabulary of words and terms with words, terms, phrases and sentences of a second vocabulary of words, terms, phrases and sentences for uses by physicians to administer and manage health, health-care and health related data on patients generated by physicians and for administering and managing said data and the derivatives and related of said data in the computers and/or servers in a network or networks of computers and servers for physicians and patients comprises:
said vocabulary of words and terms;
words, terms, phrases and sentences;
word-word couplings;
word-term couplings;
word-phrase couplings; and
word-sentence couplings.
